(19) United States
(12) Patent Application Publication
(10) Pub. No.: US 2025/0166095 A1
(43) Pub. Date: May 22, 2025

(54) METHODS, IOT SYSTEMS, AND STORAGE MEDIA FOR DEMAND MANAGEMENT OF NATURAL GAS IN DISTRIBUTED ENERGY PIPELINES

(71) Applicant: CHENGDU JIUGUAN SMART ENERGY TECHNOLOGY CO., LTD., Chengdu (CN)

(72) Inventor: Lin FU, Chengdu (CN)

(73) Assignee: CHENGDU JIUGUAN SMART ENERGY TECHNOLOGY CO., LTD., Chengdu (CN)

(21) Appl. No.: 19/031,153

(22) Filed: Jan. 17, 2025

(30) Foreign Application Priority Data
Dec. 11, 2024 (CN) 202411814720.1

(51) Int. Cl. G06Q 50/06; G16Y 10/35; G16Y 40/20; G16Y 40/35

(52) U.S. Cl. CPC G06Q 50/06; G16Y 10/35; G16Y 40/20; G16Y 40/35

(57) ABSTRACT

Provided are a method, an IoT system, and a storage medium for demand management of natural gas in distributed energy pipelines. The method includes: determining a commercial gas consumption change sequence; obtaining gas flow data; obtaining historical gas consumption data based on the gas flow data; determining a residential gas consumption change sequence; determining a demand volume sequence based on the residential gas consumption change sequence, the commercial gas consumption change sequence, and the historical gas consumption data; constructing a micro-pipeline network map based on a low-pressure transportation network, a current gas storage amount and a storage capacity of a gas field station, and the demand volume sequence; determining a gas storage coverage rate and a gas supply priority; determining a gas storage adjustment parameter based on the gas storage coverage rate and the gas supply priority; and generating a storage adjustment instruction based on the gas storage adjustment parameter.

### CROSS-REFERENCE TO RELATED APPLICATIONS

This application claims priority of Chinese Patent Application No. 202411814720.1, filed on Dec. 11, 2024, the entire contents of which are incorporated herein by reference.

### TECHNICAL FIELD

The present disclosure relates to the technical field of natural gas management, and in particular, to a method, an IoT system, and a storage medium for demand management of natural gas in distributed energy pipelines.

### BACKGROUND

In some remote areas (e.g., towns, villages, or the like) not yet covered by natural gas pipeline networks, gas is usually supplied through micro gas pipeline networks. By simply constructing low-pressure pipelines and other natural gas facilities within the remote areas, gas supply can be achieved, reducing connection costs for rural users and significantly improving the living environment in the remote areas. Therefore, it is crucial to promptly understand the changes in gas demand in various regions to deliver adequate amounts of gas to storage tanks in a timely manner.

Therefore, it is desirable to provide a method, an IoT system, and a storage medium for demand management of natural gas in distributed energy pipelines, in order to determine gas demand in remote areas and regulate gas storage amounts in the remote areas based on the gas demand.

### SUMMARY

One or more embodiments of the present disclosure provide a method for demand management distributed energy pipeline natural gas, the method being executed by a distributed energy demand management platform of an Internet of Things (IoT) system for demand management of natural gas in distributed energy pipelines. The method comprises: determining a commercial gas consumption change sequence in at least one gas supply region in a predetermined future time period based on a production parameter sequence and a commercial impact sequence of factories in the at least one gas supply region in the predetermined future time period; obtaining gas flow data of a low-pressure transportation network in the at least one gas supply region via a distributed energy sensing network platform through a distributed energy sensing control platform; obtaining historical gas consumption data of the at least one gas supply region based on the gas flow data; determining a residential gas consumption change sequence for the at least one gas supply region in the predetermined future time period based on a historical gas cost, the historical gas consumption data, seasonal information, and a gas cost sequence of the at least one gas supply region in the predetermined future time period; and determining a demand volume sequence for the at least one gas supply region in the predetermined future time period based on the residential gas consumption change sequence, the commercial gas consumption change sequence, and the historical gas consumption data. The method further comprises: constructing a micro-pipeline network map for the at least one gas supply region based on the low-pressure transportation network in the at least one gas supply region, a current gas storage amount of a gas field station, the demand volume sequence, and a storage capacity of the gas field station; determining a gas storage coverage rate and a gas supply priority of at least one node based on the micro-pipeline network map; determining a gas storage adjustment parameter based on the gas storage coverage rate and the gas supply priority, the gas storage adjustment parameter including a gas supply volume, a gas supply location, and a gas supply time of the gas field station; and generating a storage adjustment instruction based on the gas storage adjustment parameter.

One or more embodiments of the present disclosure provide an Internet of Things (IoT) system for demand management of natural gas in distributed energy pipelines, comprising a distributed energy sensing control platform, a distributed energy sensing network platform, a distributed energy demand management platform, a distributed energy service platform, and a distributed energy user platform that are connected in sequence. The distributed energy demand management platform is configured to: determine a commercial gas consumption change sequence in at least one gas supply region in a predetermined future time period based on a production parameter sequence and a commercial impact sequence of factories in the at least one gas supply region in the predetermined future time period; obtain gas flow data of a low-pressure transportation network in the at least one gas supply region via the distributed energy sensing network platform through the distributed energy sensing control platform; obtain historical gas consumption data of the at least one gas supply region based on the gas flow data; determine a residential gas consumption change sequence for the at least one gas supply region in the predetermined future time period based on a historical gas cost, the historical gas consumption data, seasonal information, and a gas cost sequence of the at least one gas supply region in the predetermined future time period; and determine a demand volume sequence for the at least one gas supply region in the predetermined future time period based on the residential gas consumption change sequence, the commercial gas consumption change sequence, and the historical gas consumption data. The distributed energy demand management platform is further configured to: construct a micro-pipeline network map for the at least one gas supply region based on the low-pressure transportation network in the at least one gas supply region, a current gas storage amount of a gas field station, the demand volume sequence, and a storage capacity of the gas field station; determine a gas storage coverage rate and a gas supply priority of at least one node based on the micro-pipeline network map; determine a gas storage adjustment parameter based on the gas storage coverage rate and the gas supply priority, the gas storage adjustment parameter including a gas supply volume, a gas supply location, and a gas supply time of the gas field station; and generate a storage adjustment instruction based on the gas storage adjustment parameter.

One or more embodiments of the present disclosure provide a non-transitory computer-readable storage medium storing computer instructions, wherein when reading the computer instructions in the storage medium, a computer implements the method for demand management of natural gas in distributed energy pipelines.

The beneficial effects include: based on the influencing factors of gas usage and the historical gas consumption data, the gas demand volume is estimated for the predetermined future period, resulting in a gas demand prediction that is closer to the actual situation. By determining the gas storage coverage rate and gas supply priority for each supply region based on the micro-pipeline network map, and determining the gas storage adjustment parameter based on the gas storage coverage rate and supply priority, it ensures the normal gas supply to the supply regions without affecting the normal production and living activities of gas users.

### BRIEF DESCRIPTION OF THE DRAWINGS

This description will be further explained in the form of exemplary embodiments, which will be described in detail by means of accompanying drawings. These embodiments are not restrictive, in which the same numbering indicates the same structure, wherein:

FIG. 1 is an exemplary block diagram of an Internet of Things (IoT) system for demand management of natural gas in distributed energy pipelines according to some embodiments of the present disclosure;

FIG. 2 is a flowchart of an exemplary process of a method for demand management of natural gas in distributed energy pipelines according to some embodiments of the disclosure;

FIG. 3 is a flowchart of an exemplary process for adjusting a commercial gas consumption change sequence and a residential gas consumption change sequence according to some embodiments of the present disclosure; and

FIG. 4 is a block diagram of an exemplary scheduling model according to some embodiments of the disclosure.

### DETAILED DESCRIPTION

The technical schemes of embodiments of the present disclosure will be more clearly described below, and the accompanying drawings need to be configured in the description of the embodiments will be briefly described below. Obviously, the drawings in the following description are merely some examples or embodiments of the present disclosure, and will be applied to other similar scenarios according to these accompanying drawings without paying creative labor. Unless obviously obtained from the context or the context illustrates otherwise, the same numeral in the drawings refers to the same structure or operation.

It should be understood that the “system”, “device”, “unit” and/or “module” used herein is a method for distinguishing different components, elements, components, parts or assemblies of different levels. However, if other words may achieve the same purpose, the words may be replaced by other expressions.

The flowcharts are used in present disclosure to illustrate the operations performed by the system according to the embodiment of the present disclosure. It should be understood that the preceding or following operations is not necessarily performed in order to accurately. Instead, the operations may be processed in reverse order or simultaneously. Moreover, one or more other operations may be added to the flowcharts. One or more operations may be removed from the flowcharts.

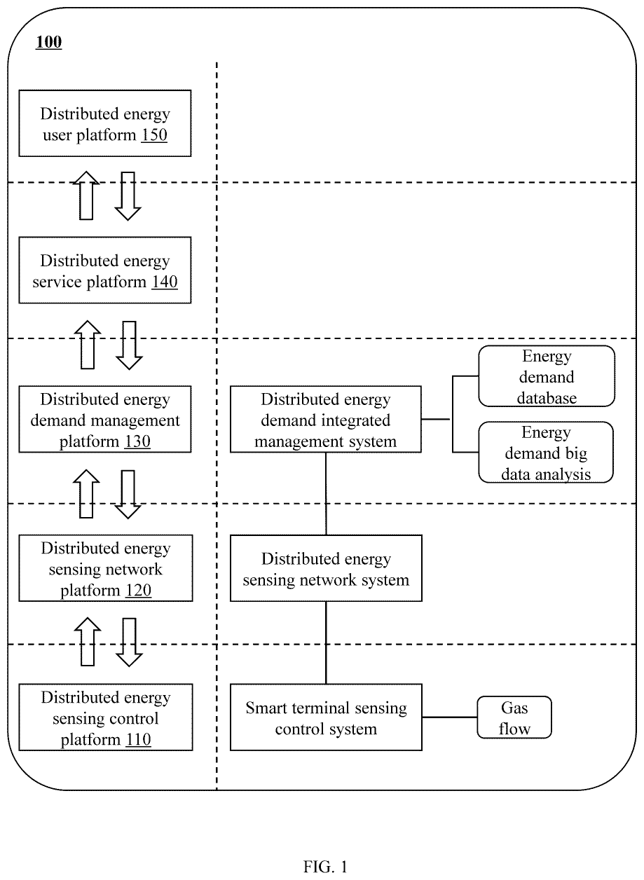

FIG. 1 is an exemplary block diagram of an Internet of Things (IoT) system for demand management of natural gas in distributed energy pipelines according to some embodiments of the present disclosure.

As shown in FIG. 1, an Internet of Things (IoT) system 100 (hereinafter referred to as an IoT system 100) for demand management of natural gas in distributed energy pipelines includes a distributed energy sensing control platform 110, a distributed energy sensing network platform 120, a distributed energy demand management platform 130, a distributed energy service platform 140, and a distributed energy user platform 150 that are connected in sequence.

The distributed energy sensing control platform 110 is a functional platform for generating sensing information and executing control information in a low-pressure transportation network. In some embodiments, the distributed energy sensing control platform 110 includes a smart terminal sensing control system. The smart terminal sensing control system is a system for obtaining gas flow data from the low-pressure transportation network in each gas supply region. The distributed energy sensing control platform 110 is configured to obtain the gas flow data of the low-pressure transportation network of at least one gas supply region based on the smart terminal sensing control system, etc. The distributed energy sensing control platform 110 may interact with the distributed energy sensing network platform 120 for data exchange. For example, the distributed energy sensing control platform 110 may upload the acquired gas flow data to the distributed energy sensing network platform 120.

The distributed energy sensing network platform 120 is a functional platform for managing sensing communications. In some embodiments, the distributed energy sensing network platform 120 includes a distributed energy sensing network system. The distributed energy sensing network system is a system for controlling sensors to obtain sensing data. The distributed energy sensing network platform 120 is configured to acquire the gas flow data based on the distributed energy sensing network system. The distributed energy sensing network platform 120 may interact with the distributed energy demand management platform 130 for data exchange. For example, the distributed energy sensing network platform 120 may transmit the gas flow data to the distributed energy demand management platform 130.

The distributed energy demand management platform 130 is a platform that coordinates and harmonizes connections and collaborations among various functional platforms, aggregates all information of the IoT system, and provides sensing management and control management functions for the operation of the IoT system. In some embodiments, the distributed energy demand management platform 130 includes a distributed energy demand integrated management system. The distributed energy demand integrated management system is a system for managing gas demand for gas supply regions. The distributed energy demand management platform 130 is configured to perform a method for demand management of natural gas in distributed energy pipelines. The distributed energy demand management platform 130 is configured to perform an energy demand big data analysis based on an energy demand database in the distributed energy demand integrated management system. The energy demand database is a database containing gas demand data of each gas supply region. The energy demand big data analysis refers to a big data analysis of gas demand in each gas supply region based on historical data.

The distributed energy service platform 140 is a platform for communicating user demand and control information. In some embodiments, the distributed energy service platform 140 may interact with the distributed energy user platform 150 for data exchange. For example, the distributed energy service platform 140 may receive a production plan uploaded by the distributed energy user platform 150.

The distributed energy user platform 150 is a platform for interacting with users. In some embodiments, the distributed energy user platform 150 may include a terminal, a server, etc.

In some embodiments, the IoT system 100 may further include a processor. Each of the platforms described above may be set up on the processor and communicatively connected via a network. The processor may be configured to process information and data related to the IoT system 100 to perform one or more of the functions described in the present disclosure. The processor may be configured to process data and information obtained from each of the above platforms.

In some embodiments, the processor may include a computer, a user console, a single processor, a processor group, or the like. The processor group may be centralized or distributed. The processor is implemented on a cloud platform.

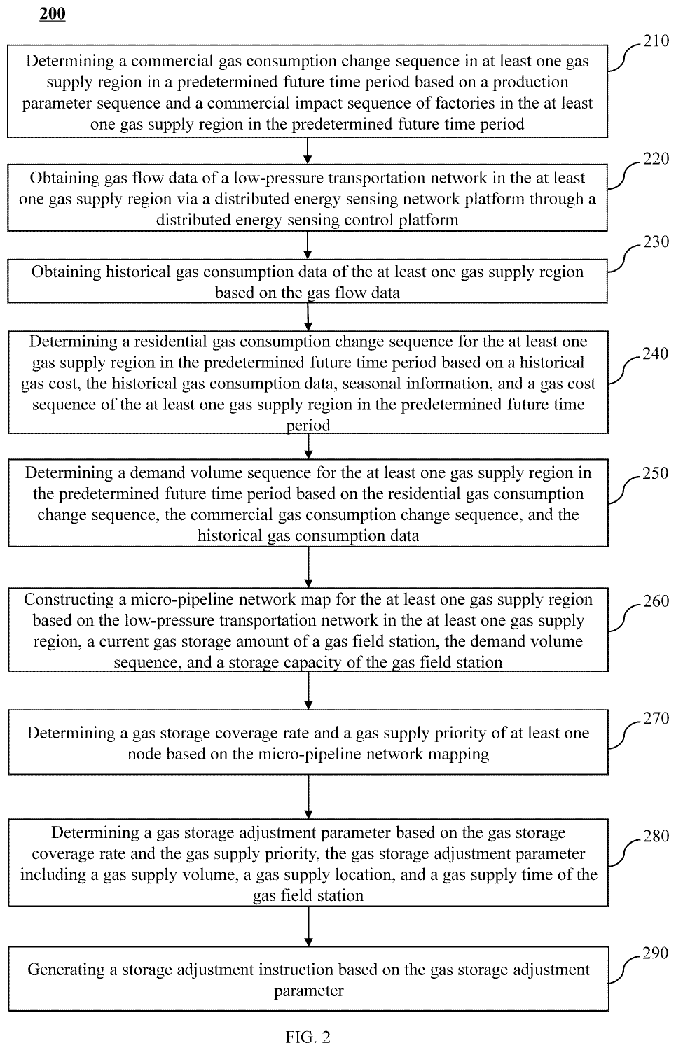

Detailed description of the foregoing can be found in the descriptions of FIG. 2 to FIG. 4.

Based on the IoT system for demand management of natural gas in distributed energy pipelines, a closed loop of information operation between the various functional platforms, allowing for coordinated, regulated operations and achieving information-based and intelligent transformation of smart gas networks. This is beneficial for the construction of micro pipeline networks in villages and towns, and can achieve platform-based management of distributed natural gas energy.

FIG. 2 is a flowchart of an exemplary process of a method for demand management of natural gas in distributed energy pipelines according to some embodiments of the disclosure. As shown in FIG. 2, process 200 includes the following operations. Process 200 is performed by the distributed energy demand management platform 130 of the IoT system 100.

In 210, determining a commercial gas consumption change sequence in at least one gas supply region in a predetermined future time period based on a production parameter sequence and a commercial impact sequence of factories in the at least one gas supply region in the predetermined future time period.

The gas supply region is an area where gas is supplied to a user. In some embodiments, the at least one gas supply region is one or more townships within a preset range. For example, each gas supply region corresponds to one of the one or more townships.

A gas field station is used to receive and store gas from upstream and supply gas to the gas supply region. The preset range may be determined based on administrative divisions.

The predetermined future time period is a time period after a current moment. For example, the predetermined future time period is an hour, a day, etc., after the current moment.

In some embodiments, the distributed energy demand management platform divides the predetermined future time period into a plurality of sub-periods. For example, when the predetermined future time period is one hour after the current moment, each of the sub-periods may be ten minutes.

The production parameter sequence is a sequence consisting of production parameters for a factory. For example, the production parameter sequence includes a plurality of production parameters of the factory corresponding to the plurality of sub-periods. Each production parameter includes, among other things, a production scale of the factory.

The production scale is a total number of products produced by the at least one factory in a sub-period. In some embodiments, a staff member in the at least one factory uploads a production plan via a distributed energy user platform, and a distributed energy demand management platform may, via a distributed energy service platform, interact with the distributed energy user platform to obtain the production plan, and determine the production scale of the factory based on the production plan.

The commercial impact sequence is a sequence consisting of commercial gas impact factors. For example, the commercial impact sequence includes a plurality of commercial gas impact factors corresponding to the plurality of sub-periods. Each commercial gas impact factor may be expressed in terms of sales of products produced by the factory in a corresponding sub-period.

In some embodiments, a staff member in the factory counts the sales of the products in each of the same sub-periods in historical data, obtains the commercial impact sequence, and uploads the commercial impact sequence to the distributed energy user platform.

The commercial gas consumption change sequence is a sequence consisting of commercial gas consumption change coefficients. For example, the commercial gas consumption change sequence includes a plurality of commercial gas consumption change coefficients corresponding to a plurality of sub-periods. Each commercial gas consumption change coefficient reflects a commercial gas usage rate in the corresponding sub-period.

In some embodiments, the distributed energy demand management platform may determine the commercial gas consumption change coefficients corresponding to the sub-periods based on the production parameters and the commercial gas impact factors corresponding to the sub-periods by querying a first predetermined table, thereby obtaining the commercial gas consumption change sequence.

The first predetermined table includes a correspondence between the production parameters, the commercial gas impact factors, and the commercial gas consumption change coefficients. The distributed energy demand management platform may determine an average commercial gas usage rate corresponding to a production parameter and a commercial gas impact factor in the historical data, and determine the average commercial gas usage rate as the commercial gas consumption change coefficient corresponding to the production parameter and the commercial gas impact factor.

In 220, obtaining gas flow data of a low-pressure transportation network in the at least one gas supply region via a distributed energy sensing network platform through a distributed energy sensing control platform.

The low-pressure transportation network refers to a transportation network consisting of low-pressure gas pipelines. For example, the low-pressure transportation network includes gas transportation paths and corresponding gas flow data, etc. in the gas supply region. A pressure corresponding to the low-pressure transportation network may be between 0.1 MPa and 0.3 MPa. The pressure corresponding to the low-pressure transportation network may also be preset according to actual needs.

The gas flow data refers to a gas flow rate of gas passing through the low-pressure gas pipelines. The gas flow data includes commercial gas flow data and residential gas flow data. The commercial gas flow data refers to a gas flow rate of gas passing through the low-pressure gas pipelines to factories. The commercial gas flow data refers to a gas flow rate of gas passing through the low-pressure gas pipelines to residential areas.

In some embodiments, the distributed energy sensing control platform measures and obtains the gas flow data through gas flow meters installed on the low-pressure gas pipelines, and uploads the gas flow data to the distributed energy demand management platform via the distributed energy sensing network platform.

In 230, obtaining historical gas consumption data of the at least one gas supply region based on the gas flow data.

The historical gas consumption data refers to a gas usage volume in the sub-period before a current moment. The historical gas consumption data includes historical residential gas consumption data and historical commercial gas consumption data.

In some embodiments, the distributed energy demand management platform determines an amount of change of the commercial gas flow data in the sub-period before the current moment to obtain the historical commercial gas consumption data, and determines an amount of change of the residential gas flow data in the sub-period before the current moment to obtain the historical residential gas consumption data.

In 240, determining a residential gas consumption change sequence for the at least one gas supply region in the predetermined future time period based on a historical gas cost, the historical gas consumption data, seasonal information, and a gas cost sequence of the at least one gas supply region in the predetermined future time period.

The seasonal information refers to information of time periods that are relevant to agricultural production. For example, the seasonal information includes the twenty-four solar terms, etc.

In some embodiments, the distributed energy demand management platform determines the seasonal information based on the current moment.

The gas cost sequence is a sequence consisting of costs of gas used by residents. For example, the gas cost sequence includes the costs of gas used by the residents corresponding to the plurality of sub-periods.

In some embodiments, the distributed energy demand management platform may obtain the gas cost sequence based on notifications or policies issued by the government.

The historical gas cost refers to a cost of gas used by the residents in the sub-period before the current moment.

The residential gas consumption change sequence refers to a sequence consisting of a plurality of residential gas consumption change coefficients. For example, the residential gas consumption change sequence includes a plurality of residential gas consumption change coefficients corresponding to the plurality of sub-periods. Each residential gas consumption change coefficient is a ratio of a residential gas usage volume in the corresponding sub-period to the residential gas usage volume in a previous sub-period.

In some embodiments, the distributed energy demand management platform determines the residential gas consumption change coefficient corresponding to a next sub-period by querying a second preset table based on the gas cost in the previous sub-period, the gas cost in the next sub-period, and the seasonal information.

The second preset table includes a correspondence between the residential gas consumption change coefficient corresponding to the next sub-period and the gas cost in the previous sub-period, the gas cost in the next sub-period, and the seasonal information. The distributed energy demand management platform may obtain, in the historical data, the residential gas usage volume and the gas cost in a sub-period before a historical moment, the residential gas usage volume and the gas cost in a sub-period after the historical moment, and the seasonal information. Then the distributed energy demand management platform may determine a ratio of the residential gas usage volume in the sub-period before the historical moment to the residential gas usage volume in the sub-period after the historical moment, and construct the second preset table based on the ratio.

In some embodiments, the distributed energy demand management platform may determine, based on the commercial gas consumption change sequence, a commercial gas demand volume corresponding to each of the sub-periods. For example, the distributed energy demand management platform determines a product of the commercial gas consumption change coefficient in a sub-period and a length of the sub-period as the commercial gas demand volume in the sub-period.

In some embodiments, the distributed energy demand management platform may perform one or more round of iterations to determine the residential gas consumption change sequence for each gas supply region in the predetermined future time period based on the historical gas cost, the historical gas consumption data, the seasonal information, and the gas cost sequence of the gas supply region in the predetermined future time period. For example, the distributed energy demand management platform may obtain the residential gas consumption change coefficient corresponding to a first sub-period by querying the second preset table based on the historical gas cost, the seasonal information, and the gas cost corresponding to the first sub-period, and determine a product of the residential gas consumption change coefficient and the historical residential gas consumption data corresponding to the first sub-period as a residential gas demand volume corresponding to the first sub-period. The distributed energy demand management platform may obtain the residential gas consumption change coefficient corresponding to the second sub-period by querying the second preset table based on the gas cost corresponding to the first sub-period, the seasonal information, and the gas cost corresponding to a second sub-period, and determine a product of the residential gas consumption change coefficient corresponding to the second sub-period and the residential gas demand volume corresponding to the first sub-period as the residential gas demand volume corresponding to the second sub-period. In this way, the residential gas consumption change sequence for each gas supply region in the predetermined future time period is obtained.

In 250, determining a demand volume sequence for the at least one gas supply region in the predetermined future time period based on the residential gas consumption change sequence, the commercial gas consumption change sequence, and the historical gas consumption data.

The demand volume sequence is a sequence consisting of gas demand volumes required by gas users during each sub-period within the predetermined future time period in the gas supply region. The gas demand volume includes the residential gas demand volume and the commercial gas demand volume.

In some embodiments, for each of the sub-periods, the distributed energy demand management platform sums the commercial gas demand volume and the residential gas demand volume during the sub-period determined in operation 240 to obtain the gas demand volume for the sub-period, and thus obtains the demand volume sequence for each of the at least one gas supply region in the predetermined future time period.

In some embodiments, the distributed energy demand management platform may perform one or more round of iterations to obtain the demand volume sequence based on the residential gas consumption change sequence, the commercial gas consumption change sequence, and the historical gas consumption data. For example, the distributed energy demand management platform may determine a product of the historical residential gas consumption data and a first residential gas consumption change coefficient in the residential gas consumption change sequence to obtain the residential gas demand volume corresponding to the first sub-period, determine a product of the historical commercial gas consumption data and a first commercial gas consumption change coefficient in the commercial gas consumption change sequence to obtain the commercial gas demand volume corresponding to the first sub-period, and determine a sum of the residential gas demand volume and the commercial gas demand volume corresponding to the first sub-period as the gas demand volume corresponding to the first sub-period. The distributed energy demand management platform determines a product of the residential gas demand volume corresponding to the first sub-period and a second residential gas consumption change coefficient in the residential gas consumption change sequence to obtain the residential gas demand volume corresponding to the second sub-period, determines a product of the commercial gas demand volume corresponding to the first sub-period and a second commercial gas consumption change coefficient in the commercial gas consumption change sequence to obtain the commercial gas demand volume corresponding to the second sub-period, and determine a sum of the residential gas demand volume and the commercial gas demand volume corresponding to the second sub-period as the gas demand volume corresponding to the second sub-period. In this way, after one or more round of iterations, the distributed energy demand management platform obtains the demand volume sequence.

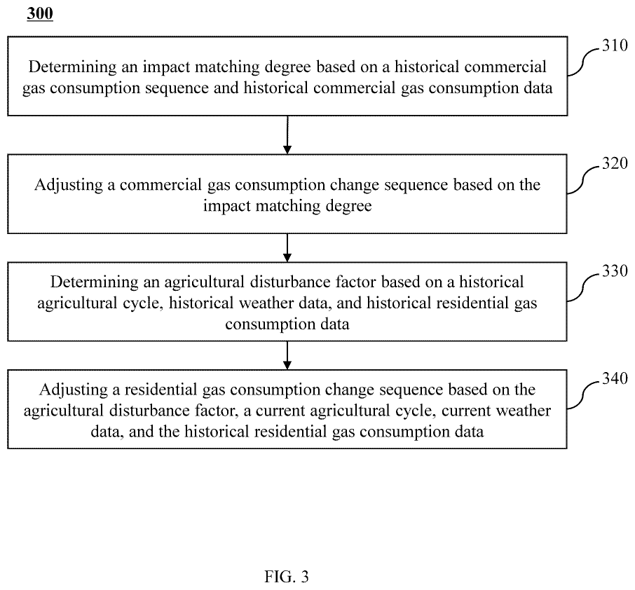

In some embodiments, the distributed energy demand management platform adjusts the commercial gas consumption change sequence and the residential gas consumption change sequence. More descriptions of the adjustment of the commercial gas consumption change sequence and the residential gas consumption change sequence may be found in FIG. 3 and the related descriptions thereof.

In 260, constructing a micro-pipeline network map for the at least one gas supply region based on the low-pressure transportation network in the at least one gas supply region, a current gas storage amount of a gas field station, the demand volume sequence, and a storage capacity of the gas field station.

The current gas storage amount refers to a total amount of gas currently stored in the gas field station.

In some embodiments, the distributed energy sensing control platform obtains an input gas flow rate and an output gas flow rate at a gas inlet and a gas outlet of the gas field station by through gas flow meters installed at the gas inlet and the gas outlet of the gas field station, determines the current gas storage amount of the gas field station, and uploads the current gas storage amount to the distributed energy demand management platform through the distributed energy sensing network platform. The distributed energy sensing control platform may also measure a pressure of the gas field station through a pressure gauge installed in the gas field station, and determine the current gas storage amount of the gas field station based on the pressure and a volume of the gas field station.

The storage capacity of the gas field station refers to a maximum amount of gas that may be stored in the gas field station.

In some embodiments, the distributed energy demand management platform may obtain the storage capacity of the gas field station based on a product parameter of the gas field station.

The micro-pipeline network map is a map reflecting the gas supply in at least one gas supply region. The micro-pipeline network map includes data related to the at least one gas supply region and a correlation between each gas supply region of the at least one gas supply region.

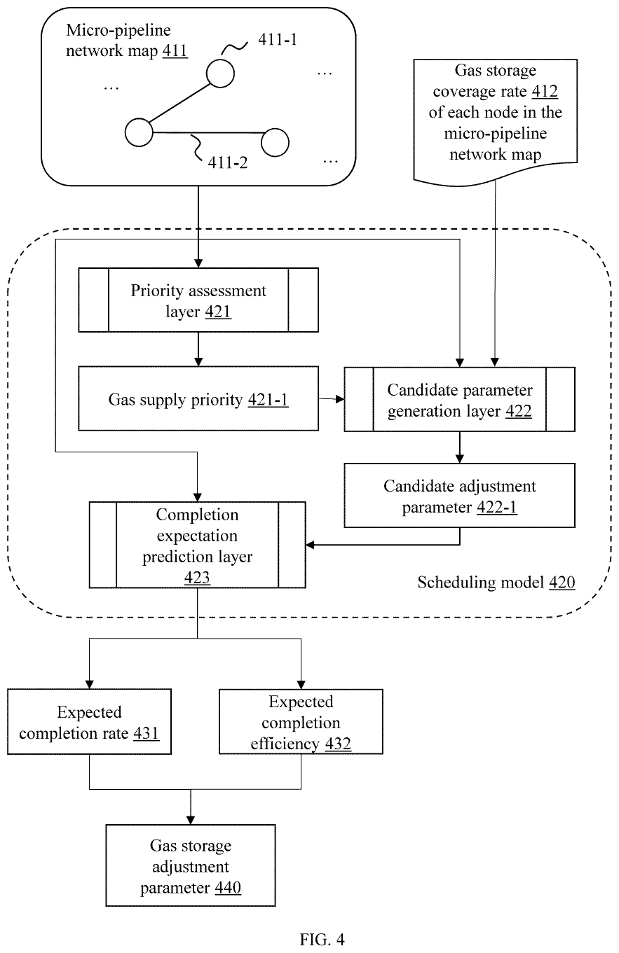

In some embodiments, a micro-pipeline network map 411 includes a plurality of nodes 411-1, each node corresponding to a gas supply region, as shown in FIG. 4. Each node has a corresponding node characteristic, the node characteristic includes the low-pressure transportation network in the gas supply region corresponding to the node, the current gas storage amount of the gas field station in the gas supply region, the storage capacity of the gas field station, the demand volume sequence of the gas supply region in the predetermined future time period, or the like.

For example, if a node 1 in the micro-pipeline network map corresponds to a gas supply region A, the node characteristic of the node 1 includes a low-pressure transportation network of the gas supply region A, a current gas storage amount of a gas field station in the gas supply region A, a storage capacity of the gas field station, and a demand volume sequence of the gas supply region A in the predetermined future time period, or the like.

In some embodiments, the micro-pipeline network map further includes a plurality of edges 411-2 connecting the nodes, with each edge corresponding to a tanker transportation path between two gas supply regions. Each edge has a corresponding edge characteristic, the edge characteristic includes a path distance, a path flatness, etc., corresponding to the tanker transportation path.

For example, the node 1 and a node 2 are connected by an edge, the node 1 corresponds to the gas supply region A, and the node 2 corresponds to a gas supply region B. Then, the edge between the node 1 and the node 2 is a tanker transportation path between the gas supply region A and the gas supply region B, and the corresponding edge characteristic includes a path distance and a path flatness corresponding to the tanker transportation path between the gas supply region A and the gas supply region B.

Gas transportation between different gas supply regions is carried out by tankers transporting storage tanks, and the distributed energy demand management platform may determine the tanker transportation path based on a traffic transportation network. The traffic transportation network refers to a transportation network between various gas supply regions. In some embodiments, the distributed energy demand management platform determines the traffic transportation network based on a map.

The path flatness refers to a degree of flatness of the tanker transportation path. The path flatness may reflect a convenience level of tanker transportation. The path flatness is expressed through the International Roughness Index (IRI).

In some embodiments, after the tanker transportation is completed, a transporter updates the path flatness of the tanker transportation path in real time based on an actual transportation condition.

In some embodiments, the distributed energy demand management platform updates data in the micro-pipeline network map according to an update frequency. The update frequency may be a system preset value. The distributed energy demand management platform may update the micro-pipeline network map at intervals of a length of the predetermined future time period. The update frequency is inversely proportional to the length of the predetermined future time period.

In some embodiments, the distributed energy demand management platform adjusts the update frequency of the micro-pipeline network map based on a fluctuation magnitude of the demand volume sequence in the micro-pipeline network map.

The fluctuation magnitude may be expressed in a variety of ways, e.g., the fluctuation magnitude is expressed by a variance or a standard deviation of the demand volume sequence. In some embodiments, the distributed energy demand management platform determines a variance or a standard deviation of gas demand volumes for the gas supply region corresponding to each node in the micro-pipeline network map in each sub-period in the predetermined future time period, determines the variance or the standard deviation as the fluctuation magnitude corresponding to the node, and determines an average of the fluctuation magnitudes of all the nodes in the micro-pipeline network map as the fluctuation magnitude of the gas demand volume in the micro-pipeline network map.

In some embodiments, the update frequency of the micro-pipeline network map is positively correlated with the fluctuation magnitude. If the fluctuation magnitude is relatively large, the update frequency of the micro-pipeline network map is relatively high, then the length of the predetermined future time period is reduced. Ig the fluctuation magnitude is relatively small, the update frequency of the micro-pipeline network map is relatively low, then the length of the predetermined future time period is increased.

In some embodiments, in response to the fluctuation magnitude of the gas demand volume in the micro-pipeline network map being less than a first predetermined threshold, the distributed energy demand management platform decreases the update frequency of the micro-pipeline network map; in response to the fluctuation magnitude of the gas demand volume in the micro-pipeline network map being not less than the first predetermined threshold, the distributed energy demand management platform increases the update frequency of the micro-pipeline network map. The first predetermined threshold may be set based on experience.

In some embodiments, the first predetermined threshold is related to a gas usage time period. If a gas usage time period is a peak gas usage time period, the first predetermined threshold is relatively low. Conversely, if the gas usage time period is a non-peak gas usage time period, the first predetermined threshold is relatively high.

The gas usage volume is relatively high during the peak gas usage period and the corresponding fluctuation magnitude is relatively large. Therefore, the update frequency of the micro-pipeline network map may be increased to predict a latest gas demand volume in time.

In some embodiments of this disclosure, if the fluctuation magnitude of the gas demand volume is relatively small, it indicates that the change in gas consumption is not significant. Therefore, the update frequency of the micro-pipeline network map may be reduced to conserve computational resources.

In 270, determining a gas storage coverage rate and a gas supply priority of at least one node based on the micro-pipeline network map.

The gas storage coverage rate refers to a proportion of current gas storage volume that satisfies the gas demand volume. In some embodiments, the gas storage coverage rate is positively correlated with the current gas storage amount and negatively correlated with the gas demand volume. The distributed energy demand management platform may determine, based on the current gas storage amount and the gas demand volume of the gas supply region corresponding to a node, a length of time for which the current gas storage amount of the gas supply region corresponding to the node satisfies the gas demand volume and determine a ratio of the length of time to the predetermined future time period as the gas storage coverage rate of the node.

The gas supply priority of a node refers to a priority level for transporting gas to the node.

In some embodiments, the gas supply priority of a node is positively correlated with a total gas demand volume of the gas supply region corresponding to the node in the predetermined future time period, and negatively correlated with the gas storage coverage rate of the node. The distributed energy demand management platform may obtain the gas supply priority corresponding to a node through calculations (e.g., weighted summation) based on the gas demand volume of the gas supply region corresponding to the node in the predetermined future time period and the gas storage coverage rate of the node. Coefficients corresponding to the gas demand volume and the gas storage coverage rate may be preset based on experience.

In 280, determining a gas storage adjustment parameter based on the gas storage coverage rate and the gas supply priority.

The gas storage adjustment parameter is a parameter related to gas transportation. In some embodiments, the gas storage adjustment parameter includes a gas supply volume, a gas supply location, and a gas supply time of the gas field station.

In some embodiments, a gas storage adjustment may be performed based on gas supply from the gas field station. For example, in response to determining that a count of nodes having a gas storage coverage rate less than 100% is greater than a second predetermined threshold, for each of the nodes having a gas storage coverage rate less than 100%, the distributed energy demand management platform determines a corresponding gas supply volume based on the gas storage amount of the node and the gas demand volume of the node in the predetermined future time period, and transports gas from the gas field station to the node based on the gas supply priority of the node. The second predetermined threshold may be set based on historical experience.

In some embodiments, the gas storage adjustment may be performed based on internal regulation of the gas field station. For example, in response to the count of the nodes having a gas storage coverage rate less than 100% is not greater than the second predetermined threshold, the distributed energy demand management platform transports gas to the nodes having a gas storage coverage rate less than 100% through nodes with having a gas storage coverage rate greater than 100% and the gas field station. Merely by way of example, the distributed energy demand management platform may sequentially determine the gas storage adjustment parameter corresponding to each node based on the gas supply priority of the node. For example, the distributed energy demand management platform generates a plurality of gas storage adjustment strategies through a dynamic planning algorithm, determines gas transportation costs corresponding to the gas storage adjustment strategies based on the edge characteristic of the edge connecting a starting point and an end point of the tanker transportation path, and determines the gas storage adjustment parameter based on a gas storage adjustment strategy with a lowest gas transportation cost. The dynamic planning algorithm is a related algorithm that is predetermined in advance.

In some embodiments, if a sum of the gas storage amounts of all the nodes is less than a sum of the gas demand volumes of all the nodes in the predetermined future time period, the distributed energy demand management platform may include the gas field station in the dynamic planning algorithm, and determine the gas storage adjustment parameter according to the gas storage adjustment strategy with the lowest gas transportation cost based on the gas supply priority.

In some embodiments, the distributed energy demand management platform may also determine an expected completion rate and an expected completion efficiency of a candidate adjustment parameter through a scheduling model based on the micro-pipeline network map and the gas storage coverage rate, and determine the gas storage adjustment parameter based on the expected completion rate and the expected completion efficiency. More details may be found in the related descriptions of FIG. 4.

In 290, generating a storage adjustment instruction based on the gas storage adjustment parameter.

The storage adjustment instruction is an instruction for controlling gas transportation. In some embodiments, the distributed energy demand management platform may generate the storage adjustment instruction based on the gas storage adjustment parameter and send the storage adjustment instruction to the gas field station for regulation.

In some embodiments, in response to a current time period being a peak gas usage time period, the distributed energy demand management platform reduces a sampling frequency for the gas cost sequence, the production parameter sequence, and the commercial impact sequence in the predetermined future time period. The sampling frequency refers to a frequency for obtaining the gas cost sequence, the production parameter sequence, the commercial impact sequence, or the like, in the predetermined future time period. The distributed energy demand management platform may sample at intervals equal to the length of each sub-period in the predetermined future time period. The sampling frequency is inversely proportional to the length of each sub-period in the predetermined future time period.

The peak gas usage time period is a time period during which gas consumption is relatively high. In some embodiments, the distributed energy demand management platform identifies a time period that satisfies a predetermined condition as the peak gas usage time period. The predetermined condition may include the gas flow data being greater than a predetermined flow threshold, and the predetermined flow threshold may be set based on historical experience. The peak gas usage time period may be preset based on historical experience.

In some embodiments, the distributed energy demand management platform increases the length of each sub-period in the predetermined future time period to reduce the sampling frequency.

Reducing the sampling frequency in the predetermined future time period during the peak gas usage time period allows for faster construction of the micro-pipeline network map, which improves the speed of response in providing gas to gas supply regions that are short of gas, thereby ensuring a smooth output of gas during the peak gas usage time period.

By predicting the gas demand volume in the predetermined future time period based on influencing factors of gas usage and historical gas consumption data, the obtained gas demand volume obtained is in more line with actual situations. By determining the gas storage coverage rate and the supply priority for each supply region based on the micro-pipeline network map, and further determining the gas storage adjustment parameter based on the storage coverage rate and the supply priority, it ensures that the supply regions can be normally provided with gas without affecting the normal production and living conditions of gas users.

FIG. 3 is a flowchart of an exemplary process for adjusting a commercial gas consumption change sequence and a residential gas consumption change sequence according to some embodiments of the present disclosure.

As shown in FIG. 3, process 300 includes the following operations. In some embodiments, process 300 is performed by the distributed energy demand management platform 130 of the IoT system 100.

In some embodiments, in the iteration described in FIG. 2, the distributed energy demand management platform may adjust the commercial gas consumption change sequence and the residential gas consumption change sequence corresponding to the iteration. The distributed energy demand management platform may perform adjust the commercial gas consumption change sequence and the residential gas consumption change sequence in the iteration through the following process 300. Descriptions of the iteration as well as the commercial gas consumption change sequence and the residential gas consumption change sequence can be found in the related descriptions of FIG. 2.

In 310, determining an impact matching degree based on a historical commercial gas consumption sequence and historical commercial gas consumption data.

Further description of the historical commercial gas consumption data may be found in the description of FIG. 2.

The historical commercial gas consumption sequence refers to product sales volumes at a plurality of time points within a predetermined historical time period. The predetermined historical time period may be a sub-period before a current moment in time, or the like. The historical commercial gas consumption sequence is obtained directly from the market.

The impact matching degree refers to a degree to which the historical commercial gas consumption sequence influences the historical commercial gas consumption data.

In some embodiments, the distributed energy demand management platform may determine the impact matching degree in a variety of ways based on the historical commercial gas consumption sequence and the historical commercial gas consumption data. For example, the impact matching degree is positively correlated with an amount of change of the product sales volume and negatively correlated with an amount of change of a commercial gas usage volume during the predetermined historical time period. Merely by way of example, the impact matching degree may be calculated using Equation (1):

$$X = {\sum }_{k = 1}^{n} \frac{\vert {M}_{k} - {M}_{k - 1} \vert}{\vert {P}_{k} - {P}_{k - 1} \vert} , \qquad ( 1 )$$

wherein X denotes the impact matching degree, n denotes a total count of time points in the predetermined historical time period, Mₖ denotes a product sales volume at a time point k, and Pₖ denotes a commercial gas usage volume at the time point k.

In 320, adjusting the commercial gas consumption change sequence based on the impact matching degree.

In some embodiments, the commercial gas consumption change sequence is adjusted based on the impact matching degree. For example, the distributed energy demand management platform may adjust the commercial gas consumption change sequence in a plurality of ways. For example, the commercial gas consumption change sequence is positively correlated with the impact matching degree, and the distributed energy demand management platform may multiply each element of the commercial gas consumption change sequence by the impact matching degree to obtain an adjusted commercial gas consumption change sequence.

In 330, determining an agricultural disturbance factor based on a historical agricultural cycle, historical weather data, and historical residential gas consumption data.

Further description of the historical residential gas consumption data can be found in the related description of FIG. 2.

The historical agricultural cycle is a planting and harvesting cycle of agricultural products in historical data. For example, the historical agricultural cycle includes a planting cycle of wheat, a harvesting cycle of wheat, a planting cycle of rice, or the like. In some embodiments, the historical agricultural cycle is stored in an energy demand database, and the distributed energy demand management platform obtains the historical agricultural cycle based on the energy demand database.

The historical weather data refers to weather data in the historical data. For example, the historical weather data includes an environmental temperature, an environmental humidity level, or the like. In some embodiments, the historical weather data is acquired based on a temperature sensing device and a humidity sensing device of the distributed energy sensing control platform and stored in the energy demand database, and the distributed energy demand management platform obtains the historical weather data based on the energy demand database.

The agricultural disturbance factor refers to a degree to which the historical agricultural cycle and the historical weather data influence the historical residential gas consumption data. The agricultural disturbance factor may be obtained by statistically analyzing deviations of the historical agricultural cycle, the historical weather data, and the corresponding historical residential gas consumption data in the historical data from a standard agricultural cycle, standard weather data, and standard residential gas consumption data, respectively. The standard agricultural cycle, the standard weather data, and the standard residential gas consumption data may be preset based on experience.

In some embodiments, the distributed energy demand management platform may determine the agricultural disturbance factor in various ways based on the historical agricultural cycle, the historical weather data, and corresponding historical residential gas consumption data. For example, the agricultural disturbance factor is positively correlated with an absolute value of a first amount of change of residential gas consumption data, and the agricultural disturbance factor is positively correlated with a ratio of an absolute value of a difference between the historical agricultural cycle and the standard agricultural cycle to the standard agricultural cycle. The agricultural disturbance factor is positively correlated with a ratio of an absolute value of a difference between the historical weather data and the standard weather data to the standard weather data. The agricultural disturbance factor may be calculated using Equation (2):

$$a = \vert {b}_{2} \vert * \{ \vert c - {c}_{0} \vert / {c}_{0} + \vert d - {d}_{0} \vert / {d}_{0} \} , \qquad ( 2 )$$

wherein a denotes the agricultural disturbance factor, b₂ denotes the first amount of change of residential gas consumption data, c denotes the historical agricultural cycle, c₀ denotes the standard agricultural cycle, d denotes the historical weather data, and d₀ denotes the standard weather data.

In some embodiments, the first amount of change of residential gas consumption data reflects an amount of change of the residential gas consumption data due to changes in the agricultural cycle and the weather data. The first amount of change of residential gas consumption data refers to a difference between the historical residential gas consumption data and the standard residential gas consumption data.

In some embodiments, the difference between the historical weather data and the standard weather data is a sum of an absolute value of a difference between the historical environmental temperature and the standard environmental temperature and an absolute value of a difference between the historical environmental humidity level and the standard environmental humidity level.

In 340, adjusting the residential gas consumption change sequence based on the agricultural disturbance factor, a current agricultural cycle, current weather data, and the historical residential gas consumption data.

The current agricultural cycle refers to a planting and harvesting cycle of agricultural products for a time period corresponding to a current iteration. In some embodiments, the current agricultural cycle may be obtained based on a type of crops currently planted in each gas supply region, and the type of crops may be obtained based on a camera of a drone performing image recognition, or the like.

The current weather data refers to the environmental temperature and the environmental humidity level, etc., in the current time period. The current weather data may be obtained based on the temperature sensing device, the humidity sensing device, etc., of the distributed energy sensing control platform.

In some embodiments, the distributed energy demand management platform may adjust the residential gas consumption change sequence in a plurality of ways based on the agricultural disturbance factor, the current agricultural cycle, the current weather data, and the historical residential gas consumption data. For example, an adjusted residential gas consumption change sequence is positively correlated with the agricultural disturbance factor, negatively correlated with the historical residential gas consumption data, positively correlated with an absolute value of a difference between the current agricultural cycle and the standard agricultural cycle, and positively correlated with an absolute value of a difference between the current weather data and the standard weather data. The adjusted residential gas consumption change sequence may be calculated using Equation (3):

$$y = {k}_{3} * {y}_{0} + {k}_{4} * a * ( \vert {c}_{1} - {c}_{0} \vert + \vert {d}_{1} - {d}_{0} \vert ) / b , \qquad ( 3 )$$

wherein y denotes the adjusted residential gas consumption change sequence, y₀ denotes a pre-adjusted residential gas consumption change sequence, a denotes the agricultural disturbance factor, c₁ denotes the current agricultural cycle, c₀ denotes the standard agricultural cycle, d₁ denotes the current weather data, d₀ denotes the standard weather data, and b denotes the historical residential gas consumption data. k₃ and k₄ denote weighting coefficients, which may be preset based on experience.

In some embodiments, a magnitude relationship between k₃ and k₄ may be determined based on a magnitude relationship between the residential gas consumption change sequence and the agricultural disturbance factor. For example, if an average value of all elements in the residential gas consumption change sequence is greater than the agricultural disturbance factor, k₃ is greater than k₄. Conversely, if the average value of all elements in the residential gas consumption change sequence is smaller than the agricultural disturbance factor, k₃ is smaller than k₄.

Each of the residential gas consumption change sequence and the agricultural disturbance factor reflects a degree of impact on the residential usage data. If the residential gas consumption change sequence and the agricultural disturbance factor are relatively large, it means that their influence on the residential gas consumption data is relatively large. Therefore, a magnitude relationship between weights corresponding to the residential gas consumption change sequence and the agricultural disturbance factor may be determined based on the magnitude relationship between the residential gas consumption change sequence and the agricultural disturbance factor. The larger the degree of impact of a factor on the residential usage data is, the larger the weight of the factor is, thereby ensuring the credibility of the adjusted residential gas consumption change sequence.

In some embodiments, the distributed energy demand management platform obtains a yield prediction sequence for at least one gas supply region in a predetermined future time period, and adjusts the residential gas consumption change sequence based on an agricultural product scale in the at least one gas supply region, a planting technique, the yield prediction sequence, and the historical gas consumption data.

The yield prediction sequence refers to a sequence consisting of estimated yields of agricultural products in time periods corresponding to the predetermined future time period. In some embodiments, the distributed energy demand management platform determines the yield prediction sequence based on historical data. For example, if the predetermined future time period is September, the distributed energy demand management platform counts an average value of actual yields of agricultural products in the September of each year in the historical data as the yield prediction sequence.

In some embodiments, the distributed energy demand management platform may adjust the yield prediction sequence based on the standard residential gas consumption data and the historical residential gas consumption data of a historical future time period in the historical data.

The standard residential gas consumption data refers to a residential gas usage volume in a time period corresponding to the predetermined future time period in historical data. In some embodiments, the standard residential gas consumption data is stored in the energy demand database, and the distributed energy demand management platform obtains the standard residential gas consumption data based on the energy demand database.

In some embodiments, the distributed energy demand management platform may adjust the yield prediction sequence in a plurality of ways based on the standard residential gas consumption data and the historical residential gas consumption data. For example, an adjusted yield prediction sequence is positively correlated with a ratio of an absolute value of the difference between the historical residential gas consumption data and the standard residential gas consumption data to the standard residential gas consumption data. The adjusted yield prediction sequence may be calculated using Equation (4):

z=z₀*(|b₀−b|)/b₀) (4),

wherein z denotes the adjusted yield prediction sequence, z₀ denotes a pre-adjusted yield prediction sequence, b₀ denotes the standard residential gas consumption data, and b denotes the historical residential gas consumption data.

Adjusting the yield prediction sequence based on the standard residential gas consumption data and the historical gas consumption data in the historical future time period in the historical data further ensures the credibility of the residential gas consumption change sequence that is adjusted based on the yield prediction sequence.

The agricultural product scale refers to an area, quantity, etc., of agricultural products. In some embodiments, the agricultural product scale is stored in the energy demand database, and the distributed energy demand management platform obtains the agricultural product scale based on the energy demand database.

The planting technique refers to a technique used to plant agricultural products in the gas supply region. For example, the planting technique may include greenhouse planting, farmland planting, or the like. In some embodiments, the planting technique is stored in the energy demand database, and the distributed energy demand management platform obtains the planting technique based on the energy demand database.

In some embodiments, the distributed energy demand management platform determines a second amount of change of residential gas consumption data based on a vector database. The second amount of change of residential gas consumption data refers to an amount of change of residential gas usage volume under the influence of the agricultural product scale, the planting technique, and the yield of the agricultural products.

In some embodiments, the vector database includes a plurality of feature vectors and corresponding labels. Elements of the feature vectors include agricultural product scales, planting techniques, and yield prediction sequences in the historical data. The labels corresponding to the feature vectors include the amounts of change of the historical residential gas consumption data corresponding to the feature vectors.

The distributed energy demand management platform may select a plurality of feature vectors whose similarity with a target vector is greater than a predetermined similarity threshold, and take an average of the labels corresponding to the plurality of feature vectors as the second amount of change of residential gas consumption data. Elements of the target vector include the agricultural product scale, the planting technique, the yield prediction sequence, or the like. The predetermined similarity threshold may be preset based on experience or set artificially.

In some embodiments, the distributed energy demand management platform may adjust the residential gas consumption change sequence based on the second amount of change of residential gas consumption data and the historical residential gas consumption data in a plurality of ways. For example, the adjusted residential gas consumption change sequence is positively correlated with the second amount of change of residential gas consumption data and negatively correlated with the historical residential gas consumption data. The adjusted residential gas consumption change sequence may be calculated using Equation (5):

$$y = {k}_{5} * {y}_{0} + {k}_{6} * {b}_{3} / b , \qquad ( 5 )$$

wherein y denotes the adjusted residential gas consumption change sequence, y₀ denotes the pre-adjusted residential gas consumption change sequence, b₃ denotes the second amount of change of residential gas consumption data, and b denotes the historical residential gas consumption data. k₅ and k₆ denote weighting coefficients, which may be preset based on experience.

In some embodiments, the adjustment of the residential gas consumption change sequence may also be performed in any other feasible manner.

Adjustment of the residential gas consumption change sequence by the yield prediction sequence is useful for guiding the cultivation of agricultural products within each gas supply region.

By adjusting the commercial gas consumption change sequence based on the impact matching degree, and adjusting the residential gas consumption change sequence based on the agricultural disturbance factor, the current agricultural cycle, the current weather data, and the historical gas consumption data, it is conducive to ensuring the reliability of the commercial gas consumption change sequence and the residential gas consumption change sequence, further guiding the delivery of gas for commercial and residential uses.

FIG. 4 is a block diagram of an exemplary scheduling model according to some embodiments of the disclosure. In some embodiments, the distributed energy demand management platform 130 may determine an expected completion rate 431 and an expected completion efficiency 432 of a candidate adjustment parameter through a scheduling model 420 based on a micro-pipeline network map 411 and a gas storage coverage rate 412 of each node in the micro-pipeline network map; and determine a gas storage adjustment parameter 440 based on the expected completion rate 431 and the expected completion efficiency 432. More descriptions of the micro-pipeline network map, the gas storage coverage rate, and the gas storage adjustment parameter may be found in FIG. 2 and the related descriptions thereof.

In some embodiments, the distributed energy demand management platform may, in response to a current time period being a peak gas usage time period, perform downsampling on a demand volume sequence before inputting the micro-pipeline network map into the scheduling model. More descriptions of the demand volume sequence may be found in FIG. 2 and the related descriptions thereof.

In some embodiments, the distributed energy demand management platform may reduce an amount of data in the demand volume sequence based on a downsampling ratio. The downsampling ratio is a ratio of the amount of data in the demand volume sequence before downsampling to the amount of data in the demand volume sequence after downsampling. For example, if the downsampling ratio is 2, the distributed energy demand management platform determines an average of gas demand volumes of two consecutive sub-periods as a gas demand volume, and a length of a time period corresponding to a new gas demand volume is twice that of the sub-period before downsampling. Then the amount of data in the demand volume sequence is ½ of the original.

In some embodiments, the downsampling ratio correlates to a duration of a predetermined future time period, e.g., the downsampling ratio is positively correlated to the duration of the predetermined future time period. More descriptions of the predetermined future time period see FIG. 2 and the related description.

If the predetermined future time period is relatively long, the micro-pipeline network map is more inclined to focus on a trend of changes of the gas demand volume in the demand volume sequence. In this case, a higher downsampling ratio may be used to reduce the amount of data and retain information related to the trend of changes of the gas demand volume.

In some embodiments of the present disclosure, the demand volume sequence is downsampled during the peak gas usage time period to reduce the amount of data contained in the micro-pipeline network map, thereby improving the computational efficiency of the scheduling model.

The scheduling model is a model used to determine the expected completion rate and the expected completion efficiency. The scheduling model is a machine learning model, e.g., the scheduling model is a Graph Neural Networks (GNN) model, or the like.

In some embodiments, an input of the scheduling model includes the micro-pipeline network map 411 and the gas storage coverage rate 412 of each node in the micro-pipeline network map, and an output of the scheduling model includes the expected completion rate 431 and the expected completion efficiency 432 of a candidate adjustment parameter.

A candidate adjustment parameter is an optional gas storage adjustment parameter. The scheduling model may include a plurality of pre-stored candidate adjustment parameters.

The expected completion rate is a predicted ratio of an actual gas storage amount to the gas demand volume after performing a gas storage adjustment. In some embodiments, the expected completion rate is an average of the gas storage coverage rates of all nodes in the micro-pipeline network map after completing the gas storage adjustment.

The expected completion efficiency is a reciprocal of a predicted time required to complete the gas storage adjustment.

In some embodiments, the distributed energy demand management platform may train the scheduling model based on a first training sample set. The first training sample set may include a plurality of first training samples with a first label. For example, the distributed energy demand management platform may input the plurality of first training samples into an initial scheduling model, construct a first loss function based on an output of the initial scheduling model and the first label, and iteratively update parameters of the initial scheduling model. When an iteration completion condition is satisfied, the training of the scheduling model is completed. The distributed energy demand management platform may end the iteration and obtain the trained scheduling model. Manners of iterative updating include, but are not limited to, a gradient descent manner, and the iteration completion condition may include a convergence of the first loss function or a count of iterations reaching a threshold.

The first training sample includes a sample micro-pipeline network map and a sample gas storage coverage rate of each node in the sample micro-pipeline network map. The first label includes a sample expected completion rate and a sample expected completion efficiency corresponding to a sample candidate adjustment parameter that corresponds to the first training sample. The first training sample and the first label may be obtained based on historical data.

In some embodiments, the scheduling model may include a priority assessment layer 421, a candidate parameter generation layer 422, and a completion expectation prediction layer 423, as shown in FIG. 4.

The priority assessment layer 421 is configured to determine a gas supply priority 421-1 of each node in the micro-pipeline network map. An input of the priority assessment layer may include the micro-pipeline network map 411, and an output of the priority assessment layer may include the gas supply priority 421-1 of each node in the micro-pipeline network map. More descriptions of the gas supply priority may be found in FIG. 2 and the related descriptions thereof.

In some embodiments, the distributed energy demand management platform may obtain the priority assessment layer through training based on a second training sample set. The second training sample set may include a plurality of second training samples with a second label. The second training sample include a sample micro-pipeline network map, and the second label may include a gas supply priority of each node in the sample micro-pipeline network map corresponding to the second training sample. The distributed energy demand management platform may determine a historical micro-pipeline network map in historical data in which an actual completion degree is greater than a predetermined completion threshold after the gas storage adjustment is completed as the second training sample, and determine a gas supply priority of each node in the historical micro-pipeline network map as the second label. A training process of the priority assessment layer is the same as the training process of the scheduling model described above in FIG. 4.

The candidate parameter generation layer 422 is configured to generate the candidate adjustment parameter. An input to the candidate parameter generation layer include the micro-pipeline network map 411, the gas storage coverage rate 412 of each node in the micro-pipeline network map, and the gas supply priority 421-1 of each node in the micro-pipeline network map, and an output of the candidate parameter generation layer includes a plurality of candidate adjustment parameters 422-1.

In some embodiments, the distributed energy demand management platform may obtain the candidate parameter generation layer through training based on a third training sample set. The third training sample set may include a plurality of third training samples with a third label. The third training sample includes a sample micro-pipeline network map, a sample gas storage coverage rate and a sample gas supply priority of each node in the sample micro-pipeline network map. The third label includes a sample candidate adjustment parameter corresponding to the third training sample. The distributed energy demand management platform may obtain the third training samples based on historical data, cluster the third training samples to obtain a plurality of clustering centers, and determine historical gas storage adjustment parameters corresponding to all of the third training samples included in each clustering center as the third labels corresponding to the third training samples in the cluster center, respectively. For example, a clustering center A includes five third training samples, a1, a2, a3, a4, and a5, corresponding to historical gas storage adjustment parameters b1, b2, b3, b4, and b5, respectively. The third label corresponding to the third training sample a1 includes b1, b2, b3, b4, b5, a total of 5 sample candidate adjustment parameters, and the third label corresponding to the third training sample a2 includes b1, b2, b3, b4, b5, a total of 5 sample candidate adjustment parameters, . . . and the third label corresponding to the third training sample a5 includes b1, b2, b3, b4, b5, totaling 5 sample candidate adjustment parameters. Manners of clustering include, but are not limited to, a K-Means clustering algorithm, a DBSCAN clustering algorithm, or the like. A training process of the candidate parameter generation layer is the same as the training process of the scheduling model described above in FIG. 4.

The completion expectation prediction layer 423 is configured to determine the expected completion rate and the expected completion efficiency corresponding to the candidate adjustment parameter. An input of the completion expectation prediction layer 423 includes the micro-pipeline network map 411 and the candidate adjustment parameter 422-1, and an output of the completion expectation prediction layer 423 includes the expected completion rate 431 and the expected completion efficiency 432 corresponding to the candidate adjustment parameter 422-1.

In some embodiments, the distributed energy demand management platform may obtain the completion expectation prediction layer through training based on a fourth training sample set. The fourth training sample set may include a plurality of fourth training samples with a fourth label. The fourth training sample includes a sample micro-pipeline network map and the sample candidate adjustment parameter, and the fourth label includes a historical completion degree and a historical completion efficiency corresponding to the fourth training sample. The fourth label may be obtained based on historical data. A training process of the completion expectation prediction layer is the same as the training process of the scheduling model described in FIG. 4 above.

In some embodiments, the priority assessment layer, the candidate parameter generation layer, and the completion expectation prediction layer may be obtained by joint training based on a training sample set. The training sample set includes labeled joint training samples. The joint training samples include a sample micro-pipeline network map and a sample gas storage coverage rate, the label corresponding to the joint training sample includes a historical completion degree and a historical completion efficiency. The distributed energy demand management platform may input the sample micro-pipeline network map into an initial priority assessment layer, and obtain a gas supply priority of each node in the sample micro-pipeline network map output by the initial priority assessment layer. The gas supply priority, the sample micro-pipeline network map, and the sample gas storage coverage rate are input into an initial candidate parameter generation layer to obtain a plurality of candidate adjustment parameters output from the initial candidate parameter generation layer. The distributed energy demand management platform may input the plurality of candidate adjustment parameters and the sample micro-pipeline network map into an initial completion expectation prediction layer, obtain an expected completion rate and an expected completion efficiency output from the initial completion expectation prediction layer, and construct a joint loss function based on the expected completion rate, the expected completion efficiency, the historical completion degree, and the historical completion efficiency. Parameters of the initial priority assessment layer, the initial candidate parameter generation layer, and the initial completion expectation prediction layer are iteratively updated based on the joint loss function to obtain a trained priority assessment layer, a trained candidate parameter generation layer, and a trained completion expectation prediction layer.

In some embodiments, a count of samples in the training sample set in a collection time period is greater than a sample scale threshold. The sample scale threshold is related to a historical fluctuation amplitude of historical gas usage during the collection time period. The sample scale threshold is positively correlated with the historical fluctuation amplitude of historical gas usage during the collection time period. The collection time period is a predetermined historical time period.

In some embodiments, the distributed energy demand management platform obtains the training sample set based on historical data from a plurality of collection time periods, and the count of samples in the training sample set for each collection time period is greater than a corresponding sample scale threshold. The sample scale threshold corresponding to a collection time period is positively correlated with the historical fluctuation magnitude of historical gas consumption data during the collection time period.

In some embodiments, the distributed energy demand management platform may determine a difference between a maximum value and a minimum value of a plurality of pieces of historical gas consumption data during a collection time period as the fluctuation magnitude of the historical gas consumption data during the historical time period.

The larger the historical fluctuation amplitude of historical gas consumption data during a collection time period is, the more drastic a change of gas usage volumes in the collection time period is, thus the larger the amplitude and frequency of changes of the gas usage volumes and the micro-pipeline network map. Therefore, the count of samples in the collection time period may be increased to ensure the comprehensiveness of the training sample set.

In some embodiments, the input of the scheduling model further includes a seasonal period of the predetermined future time period. If the scheduling model is a multilayered structure (e.g., the scheduling model includes the priority assessment layer 421, the candidate parameter generation layer 422, and the completion expectation prediction layer 423), the input of the candidate parameter generation layer further includes the seasonal period of the predetermined future time period.

The seasonal period is a time period corresponding to the predetermined future time period. The distributed energy demand management platform may determine the seasonal period based on a current time and a duration of the predetermined future time period.

In some embodiments, if the input of the scheduling model or the candidate parameter generation layer includes the seasonal period of the predetermined future time period, the training sample set further includes a sample seasonal period, which may be obtained based on historical data.

The predetermined future time period may include a peak traffic time period, an inconvenient time period for tanker transportation, such as a winter road icing period, or the like. In such cases, it is necessary to consider other factors influencing a tanker transportation path and not simply take a shortest path as the tanker transportation path. By considering the season period of the predetermined future time period when generating the candidate adjustment parameter, the rationality and safety of the determined candidate adjustment parameter are enhanced.

In some embodiments, the input of the scheduling model includes a current agricultural cycle and an agricultural product scale corresponding to at least one node in the micro-pipeline network map. If the scheduling model is the multilayered structure, the input of the priority assessment layer further includes the current agricultural cycle and the agricultural product scale corresponding to the at least one node. More descriptions of the agricultural cycle and the agricultural product scale may be found in FIG. 3 and the related descriptions thereof.

In some embodiments, if the input of the scheduling model or the priority assessment layer includes the current agricultural cycle and the agricultural product scale, the training sample set further includes a sample agricultural cycle and a sample agricultural product scale. The sample agricultural cycle and the sample agricultural product scale may be obtained based on historical data.

Gas demand volume and importance vary in different stages of the agricultural cycle. For example, when agricultural products are in a seedling stage, the agricultural products are more sensitive to temperature. Therefore, in the seedling stage, it is necessary to provide temperature control equipment with a timely and sufficient supply of gas to maintain the temperature in a small range, thereby ensuring that seeds germinate successfully. The larger the agricultural product scale, the greater the loss of gas supply interruption, therefore gas supply regions (e.g., towns, etc.) corresponding to nodes with a relatively large agricultural product scale require a higher gas supply priority. Thus, considering the agricultural cycle and the agricultural product scale when estimating the priority of each node can ensure the reasonableness of the output of the scheduling model, and improve the effectiveness of the subsequently generated candidate adjustment parameter.

In some embodiments, the distributed energy demand management platform may determine a mean and a variance of expected completion rates and a mean and a variance of expected completion efficiencies corresponding to each of a plurality of candidate adjustment parameters, and determine a score for each of the plurality of candidate adjustment parameters by means of weighted summation, and determine a candidate adjustment parameter with a highest score as the final gas storage adjustment parameter to be used. A weight of the weighted summation corresponding to each candidate adjustment parameter may be set based on historical experience.

By generating a plurality of candidate adjustment parameters through the scheduling model and determining the expected completion rate and the expected completion efficiency for each candidate adjustment parameter, the final gas storage adjustment parameter is determined based on the expected completion rate and the expected completion efficiency. The gas storage adjustment is then performed based on gas storage adjustment parameter, aiming to meet the gas demand values of users to a greatest extent possible in a shortest time, thereby ensuring the normal production and life of the users.

Some embodiments of the present disclosure provide a non-transitory computer-readable storage medium that stores computer instructions. When a computer reads the computer instructions in the storage medium, the computer performs the method for demand management of natural gas in distributed energy pipelines described in the present disclosure.

The basic concepts have been described above, and it is apparent to those skilled in the art that the foregoing detailed disclosure is intended as an example only and does not constitute a limitation of this disclosure. While not expressly stated herein, a person skilled in the art may make various modifications, improvements, and amendments to this disclosure. Those types of modifications, improvements, and amendments are suggested in this disclosure, so those types of modifications, improvements, and amendments remain within the spirit and scope of the exemplary embodiments of this disclosure.

Furthermore, unless expressly stated in the claims, the order of the processing elements and sequences described herein, the use of numerical letters, or the use of other names are not intended to qualify the order of the processes and methods of this disclosure. While some embodiments of the invention that are currently considered useful are discussed in the foregoing disclosure by way of various examples, it is to be understood that such details serve only illustrative purposes and that additional claims are not limited to the disclosed embodiments, rather, the claims are intended to cover all amendments and equivalent combinations that are consistent with the substance and scope of the embodiments of this disclosure. For example, although the implementation of various components described above may be embodied in a hardware device, it may also be implemented as a software only solution, e.g., an installation on an existing server or mobile device.

Finally, it should be understood that the embodiments described in this disclosure are only used to illustrate the principles of the embodiments of this disclosure. Other deformations may also fall within the scope of this disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A method for demand management of natural gas in distributed energy pipelines, the method being executed by a distributed energy demand management platform of an Internet of Things (IoT) system for demand management of natural gas in distributed energy pipelines, and the method comprising:
determining a commercial gas consumption change sequence in at least one gas supply region in a predetermined future time period based on a production parameter sequence and a commercial impact sequence of factories in the at least one gas supply region in the predetermined future time period;
obtaining gas flow data of a low-pressure transportation network in the at least one gas supply region via a distributed energy sensing network platform through a distributed energy sensing control platform;
obtaining historical gas consumption data of the at least one gas supply region based on the gas flow data;
determining a residential gas consumption change sequence for the at least one gas supply region in the predetermined future time period based on a historical gas cost, the historical gas consumption data, seasonal information, and a gas cost sequence of the at least one gas supply region in the predetermined future time period;
determining a demand volume sequence for the at least one gas supply region in the predetermined future time period based on the residential gas consumption change sequence, the commercial gas consumption change sequence, and the historical gas consumption data;
constructing a micro-pipeline network map for the at least one gas supply region based on the low-pressure transportation network in the at least one gas supply region, a current gas storage amount of a gas field station, the demand volume sequence, and a storage capacity of the gas field station;
determining a gas storage coverage rate and a gas supply priority of at least one node based on the micro-pipeline network map;
determining a gas storage adjustment parameter based on the gas storage coverage rate and the gas supply priority, the gas storage adjustment parameter including a gas supply volume, a gas supply location, and a gas supply time of the gas field station; and
generating a storage adjustment instruction based on the gas storage adjustment parameter.

2. The method of claim 1, further comprising:
in response to a current time period being a peak gas usage time period, reducing a sampling frequency for the gas cost sequence, the production parameter sequence, and the commercial impact sequence in the predetermined future time period.

3. The method of claim 1, further comprising:
adjusting an update frequency of the micro-pipeline network map based on a fluctuation magnitude of the demand volume sequence in the micro-pipeline network map.

4. The method of claim 1, further comprising:
determining an impact matching degree based on a historical commercial gas consumption sequence and historical commercial gas consumption data;
adjusting the commercial gas consumption change sequence based on the impact matching degree;
determining an agricultural disturbance factor based on a historical agricultural cycle, historical weather data, and historical residential gas consumption data; and
adjusting the residential gas consumption change sequence based on the agricultural disturbance factor, a current agricultural cycle, current weather data, and the historical residential gas consumption data.

5. The method of claim 4, further comprising:
obtaining a yield prediction sequence for the at least one gas supply region in the predetermined future time period; and
adjusting the residential gas consumption change sequence based on an agricultural product scale in the at least one gas supply region, a planting technique, the yield prediction sequence, and the historical gas consumption data.

6. The method of claim 5, wherein the obtaining a yield prediction sequence for the at least one gas supply region in the predetermined future time period includes:
adjusting the yield prediction sequence based on standard residential gas consumption data and the historical gas consumption data in a historical future time period in historical data.

7. The method of claim 1, further comprising:
determining an expected completion rate and an expected completion efficiency of a candidate adjustment parameter through a scheduling model based on the micro-pipeline network map and the gas storage coverage rate, the scheduling model being a machine learning model; and
determining the gas storage adjustment parameter based on the expected completion rate and the expected completion efficiency.

8. The method of claim 7, further comprising:
in response to a current time period being a peak gas usage time period, performing downsampling on the demand volume sequence before inputting the micro-pipeline network map into the scheduling model.

9. The method of claim 7, wherein an input of the scheduling model includes a seasonal period of the predetermined future time period.

10. The method of claim 7, wherein the scheduling model is obtained by training based on a training sample set, and a count of samples in the training sample set in a collection time period is greater than a sample scale threshold, the sample scale threshold being related to a historical fluctuation amplitude of historical usage during the collection time period.

11. The method of claim 7, wherein an input of the scheduling model includes a current agricultural cycle and an agricultural product scale corresponding to the at least one node.

12. An Internet of Things (IoT) system for demand management of natural gas in distributed energy pipelines, comprising a distributed energy sensing control platform, a distributed energy sensing network platform, a distributed energy demand management platform, a distributed energy service platform, and a distributed energy user platform that are connected in sequence, wherein the distributed energy demand management platform is configured to:
determine a commercial gas consumption change sequence in at least one gas supply region in a predetermined future time period based on a production parameter sequence and a commercial impact sequence of factories in the at least one gas supply region in the predetermined future time period;
obtain gas flow data of a low-pressure transportation network in the at least one gas supply region via the distributed energy sensing network platform through the distributed energy sensing control platform;
obtain historical gas consumption data of the at least one gas supply region based on the gas flow data;
determine a residential gas consumption change sequence for the at least one gas supply region in the predetermined future time period based on a historical gas cost, the historical gas consumption data, seasonal information, and a gas cost sequence of the at least one gas supply region in the predetermined future time period;
determine a demand volume sequence for the at least one gas supply region in the predetermined future time period based on the residential gas consumption change sequence, the commercial gas consumption change sequence, and the historical gas consumption data;
construct a micro-pipeline network map for the at least one gas supply region based on the low-pressure transportation network in the at least one gas supply region, a current gas storage amount of a gas field station, the demand volume sequence, and a storage capacity of the gas field station;
determine a gas storage coverage rate and a gas supply priority of at least one node based on the micro-pipeline network map;
determine a gas storage adjustment parameter based on the gas storage coverage rate and the gas supply priority, the gas storage adjustment parameter including a gas supply volume, a gas supply location, and a gas supply time of the gas field station; and
generate a storage adjustment instruction based on the gas storage adjustment parameter.

13. The system of claim 12, wherein the distributed energy demand management platform is further configured to:
in response to a current time period being a peak gas usage time period, reducing a sampling frequency for the gas cost sequence, the production parameter sequence, and the commercial impact sequence in the predetermined future time period.

14. The system of claim 12, wherein the distributed energy demand management platform is further configured to:
adjust an update frequency of the micro-pipeline network map based on a fluctuation magnitude of the demand volume sequence in the micro-pipeline network map.

15. The system of claim 12, wherein the distributed energy demand management platform is further configured to:
determine an impact matching degree based on a historical commercial gas consumption sequence and historical commercial gas consumption data;
adjust the commercial gas consumption change sequence based on the impact matching degree;
determine an agricultural disturbance factor based on a historical agricultural cycle, historical weather data, and historical residential gas consumption data; and
adjust the residential gas consumption change sequence based on the agricultural disturbance factor, a current agricultural cycle, current weather data, and the historical residential gas consumption data.

16. The system of claim 15, wherein the distributed energy demand management platform is further configured to:
obtain a yield prediction sequence for the at least one gas supply region in the predetermined future time period; and
adjust the residential gas consumption change sequence based on an agricultural product scale in the at least one gas supply region, a planting technique, the yield prediction sequence, and the historical gas consumption data.

17. The system of claim 16, wherein the distributed energy demand management platform is further configured to:
adjust the yield prediction sequence based on standard residential gas consumption data and the historical gas consumption data in a historical future time period in historical data.

18. The system of claim 12, wherein the distributed energy demand management platform is further configured to:
determine an expected completion rate and an expected completion efficiency of a candidate adjustment parameter through a scheduling model based on the micro-pipeline network map and the gas storage coverage rate, the scheduling model being a machine learning model; and
determine the gas storage adjustment parameter based on the expected completion rate and the expected completion efficiency.

19. The system of claim 18, wherein the distributed energy demand management platform is further configured to:
in response to a current time period being a peak gas usage time period, performing downsampling on the demand volume sequence before inputting the micro-pipeline network map into the scheduling model.

20. A non-transitory computer-readable storage medium storing computer instructions, wherein when reading the computer instructions in the storage medium, a computer implements the method of claim 1.
